(19) United States
(12) Patent Application Publication
(10) Pub. No.: US 2013/0030675 A1
(43) Pub. Date: Jan. 31, 2013

(54) VEHICLE CONTROL APPARATUS

(71) Applicants: Yuki Minase, Susono-shi (JP); Michihito Shimada, Mishima-shi (JP); Masashi Takagi, Nagoya-shi (JP); Tsutomu Miyazaki, Miyoshi-shi (JP); Toshiya Oishi, Nagoya-shi (JP); Kenichi Okaya, Susono-shi (JP)

(72) Inventors: Yuki Minase, Susono-shi (JP); Michihito Shimada, Mishima-shi (JP); Masashi Takagi, Nagoya-shi (JP); Tsutomu Miyazaki, Miyoshi-shi (JP); Toshiya Oishi, Nagoya-shi (JP); Kenichi Okaya, Susono-shi (JP)

(73) Assignee: TOYOTA JIDOSHA KABUSHIKI KAISHA, Toyota-shi (JP)

(21) Appl. No.: 13/639,442

(22) PCT Filed: Apr. 7, 2010
(86) PCT No.: PCT/JP2010/002537

§ 371 Date: Oct. 4, 2012

(51) Int. Cl. F02D 28/00

(52) U.S. Cl. 701/110

(57) ABSTRACT

Provided is a vehicle control apparatus that can prevent the drivability from being deteriorated. The vehicle control apparatus has an ECU which determines, when the control permission condition is not established, not to execute the reduction control in the case that the accelerator opening degree is smaller than or equal to the accelerator threshold value or the vehicle speed is smaller than or equal to the vehicle speed threshold value, even if a depression of an accelerator pedal is detected and a depression of a foot brake pedal is detected. Therefore, the vehicle control apparatus can stop the torque reduction control to prevent the reduction of the engine output contrary to the intention of the driver in the case that an impact to the vehicle is small such that a load more than necessary is not applied to the vehicle even if the accelerator pedal and the brake pedal are both depressed by the driver. As a result, the vehicle control apparatus can improve the operability of the vehicle in the situations such as hill start and overcoming steps, thereby preventing the drivability from being deteriorated.

### TECHNICAL FIELD

The present invention relates to a vehicle control apparatus, and more particularly to a vehicle control apparatus that performs a suppression control of the output of a power source.

### BACKGROUND ART

In general, a vehicle has three fundamentally necessary abilities including a “driving force” as an ability of “advancing”, a “steering force” as an ability of “turning”, and a “braking force” as an ability of “stopping”.

The “driving force” is a power, i.e., a torque generated by a power source of an internal combustion engine (hereinafter simply referred to as an “engine”) in response to such an amount of depression of an accelerator pedal and transmitted through a transmission to driving wheels to be obtained as a frictional reaction force of the driving wheels and a road surface allowing the driving wheels to travel thereon. The “steering force” is obtained by a steering device capable of changing the advancing direction of, for example, front wheels in response to the operation amount of a steering wheel. The “braking force” is generated in response to the amount of depression of a brake pedal by slowing down or stopping the rotation of the driving wheels to generate a frictional reaction force of the driving wheels and the road surface allowing the vehicle to be stopped.

In general, the accelerator pedal and the brake pedal are located adjacent to each other in the neighborhood of the location of drivers' feet. Many drivers selectively depress the accelerator pedal or the brake pedal only with his or her right foot to control the “driving force” and the “braking force”, viz., to control a vehicle speed.

In addition, a vehicle with an automatic transmission (hereinafter simply referred to as an “AT car”) is provided with no clutch pedal, thereby allowing some drivers to drive his or her car while depressing the brake pedal with his or her left foot and depressing the accelerator pedal with his or her right foot. In this way, there are some drivers who drive their cars separately using their left foot and right foot to depress the brake pedal and the accelerator pedal, respectively. For such drivers using their both feet separately for the brake pedal and the accelerator pedal, there is a possible case that the brake pedal is depressed while the accelerator pedal is not being released by the driver, or otherwise the accelerator pedal is depressed while the brake pedal is not being released by the driver.

Therefore, there are possibilities in which the deceleration is not always the intention of the driver, thereby resulting in deterioration in drivability.

There has so far been known a vehicle control apparatus which can reduce a torque of the engine in the event that the accelerator pedal and the brake pedal are depressed at the same time (see for example Patent Document 1).

The previously mentioned conventional vehicle is constructed to reduce the torque outputted by the engine with the fuel injection amount of the engine being temporarily reduced in the case that the accelerator pedal and the brake pedal are depressed at the same time.

### CITATION LIST

### Patent Literature

{Patent Document 1}
Japanese Patent Application Publication No. S62-051737

### SUMMARY OF INVENTION

### Technical Problem

However, the conventional vehicle control apparatus is constructed to uniformly reduce the fuel injection amount to the engine to reduce the torque irrespective of the vehicle travel state when the accelerator pedal and the brake pedal are depressed by the driver at the same time, thereby reducing the torque irrespective of the driver's intention. This results in the fact that the conventional vehicle control apparatus causes a vehicle hesitation and other unfavorable phenomena on the vehicle when the accelerator pedal and the brake pedal are intentionally depressed by the driver at the same time, thereby leading to problems such as deteriorated drivability.

In particular, in situations such as hill start and overcoming steps, when the accelerator pedal and the brake pedal are intentionally depressed by the driver at the same time, the vehicle is stable and a load more than necessary is not applied to a drive system. However, there has been a problem that the intention of the driver is not reflected in the conventional vehicle control apparatus, thereby unnecessarily reducing the torque to result in the deterioration of the drivability.

The present invention has been made to solve such conventional problems as previously mentioned. It is therefore an object of the present invention to provide a vehicle control apparatus which can prevent the drivability from being deteriorated.

### Solution to Problem

To solve the above problems, the vehicle control apparatus according to the present invention is, (1) provided with a power source, an accelerator pedal, and a brake pedal, the vehicle control apparatus comprising a travel state detection unit that detects a travel state of the vehicle including a required amount of a driving force to be outputted by the power source, and an output control unit that executes a reduction control to reduce the driving force to be outputted by the power source in response to the required amount of the driving force, the travel state detection unit being constituted by an accelerator detection unit that detects a depression of the accelerator pedal, and a brake detection unit that detects a depression of the brake pedal, the output control unit being configured to execute the reduction control in the case that a variation occurred by a travel state of the vehicle detected by the travel state detection unit is estimated to be out of a preset protection range of the vehicle under the condition that a prerequisite for establishing a control permission condition permitting the execution of the reduction control is satisfied, the prerequisite being that the depression of the accelerator pedal is detected by the accelerator detection unit and the depression of the brake pedal is detected by the brake detection unit, on the other hand, the output control unit being configured not to execute the reduction control in the case that the variation occurred by the travel state of the vehicle detected by the travel state detection unit is estimated to be within the preset protection range of the vehicle even if the prerequisite is satisfied.

By the construction of the vehicle control apparatus as set forth in the above definition, the output control unit is configured not to execute the reduction control in the case that the variation occurred by the travel state of the vehicle detected by the travel state detection unit is estimated to be within the preset protection range of the vehicle even if the depression of the accelerator pedal is detected by the accelerator detection unit and the depression of the brake pedal is detected by the brake detection unit. Therefore, the vehicle control apparatus according to the present invention can stop the reduction control of the driving force and can prevent a reduction of an engine output contrary to the intention of the driver in the case that an impact to the vehicle is small such that a load more than necessary is not applied to the vehicle even if the accelerator pedal and the brake pedal are both depressed by the driver. As a result, the vehicle control apparatus can improve an operability of the vehicle in situations such as hill start and overcoming steps, thereby preventing the drivability from being deteriorated.

The vehicle control apparatus according to the present invention as set forth in the above definition (1), in which (2) the accelerator detection unit is adapted to detect a depression amount of the accelerator pedal, the output control unit being configured to estimate that the variation occurred by the travel state of the vehicle is within the protection range in the case that the depression amount of the accelerator pedal detected by the accelerator detection unit is less than or equal to a predetermined value.

By the construction of the vehicle control apparatus as set forth in the above definition, the output control unit is configured to estimate that the variation occurred by the travel state of the vehicle is within the protection range in the case that the depression amount of the accelerator pedal is less than or equal to the predetermined value. Therefore, the vehicle control apparatus according to the present invention executes no reduction control and reflect the intention of the driver according to the depression amount of the accelerator pedal when the depression amount of the accelerator pedal is less than or equal to a predetermined value. As a result, the vehicle control apparatus can improve the operability of the vehicle, thereby preventing the drivability from being deteriorated.

The vehicle control apparatus according to the present invention as set forth in the above definition (1) or (2), in which (3) the travel state detection unit has a vehicle speed detection unit that detects the vehicle speed, the output control unit being configured to estimate that the variation occurred by the travel state of the vehicle is within the protection range in the case that the vehicle speed detected by the vehicle speed detection unit is smaller than or equal to a predetermined value.

By the construction of the vehicle control apparatus as set forth in the above definition, the output control unit is configured to estimate that the variation occurred by the travel state of the vehicle is within the protection range in the case that the vehicle speed is smaller than or equal to the predetermined value. Therefore, the vehicle control apparatus according to the present invention executes no reduction control and reflect the intention of the driver according to the vehicle speed when the vehicle speed is smaller than or equal to the predetermined value. As a result, the vehicle control apparatus can improve the operability of the vehicle, thereby preventing the drivability from being deteriorated.

The vehicle control apparatus according to the present invention as set forth in the above definition (1), in which (4) the travel state detection unit has a vehicle speed detection unit that detects the vehicle speed, the accelerator detection unit being adapted to detect a depression amount of the accelerator pedal, the output control unit being configured to estimate that the variation occurred by the travel state of the vehicle is within the protection range in the case that the depression amount of the accelerator pedal detected by the accelerator detection unit is less than or equal to a predetermined value and the vehicle speed detected by the vehicle speed detection unit is smaller than or equal to a predetermined value.

By the construction of the vehicle control apparatus as set forth in the above definition, the output control unit is configured to estimate that the variation occurred by the travel state of the vehicle is within the protection range in the case that the depression amount of the accelerator pedal is less than or equal to the predetermined value and the vehicle speed is smaller than or equal to the predetermined value. Therefore, the vehicle control apparatus according to the present invention executes no reduction control when the both conditions of the accelerator opening degree and the vehicle speed are satisfied. As a result, the vehicle control apparatus can strictly set non-execution conditions for the reduction control, thereby preventing the drivability from being deteriorated.

### Advantageous Effects of Invention

The present invention can provide a vehicle control apparatus which can stop the reduction control of the driving force and can prevent a reduction of an engine output contrary to the intention of the driver in the case that an impact to the vehicle is small even if the accelerator pedal and the brake pedal are both depressed by the driver. As a result, the vehicle control apparatus can improve an operability of the vehicle, thereby preventing the drivability from being deteriorated.

### BRIEF DESCRIPTION OF DRAWINGS

FIG. 1 is a schematic block diagram of a vehicle equipped with a control apparatus according to an embodiment of the present invention.

FIG. 2 is a schematic block diagram of the vehicle control according to the embodiment of the present invention.

FIG. 3 is a graph showing a deceleration threshold value set by a deceleration threshold value map in the embodiment of the present invention.

FIG. 4 is a schematic block diagram representing a construction of an automatic transmission in the embodiment of the present invention.

FIG. 5 is an operation table showing the engagement state of frictional engagement elements to realize each shift stage in the embodiment of the present invention.

FIG. 6 is a schematic block diagram representing a construction of a front differential mechanism and a transfer in the embodiment of the present invention.

FIG. 7 is a flowchart showing a vehicle control process in the first embodiment of the present invention.

FIG. 8 is a flowchart showing a vehicle control process in the second embodiment of the present invention.

### DESCRIPTION OF EMBODIMENTS

The embodiments of the invention will be described hereinafter with reference to the drawings.

### First Embodiment

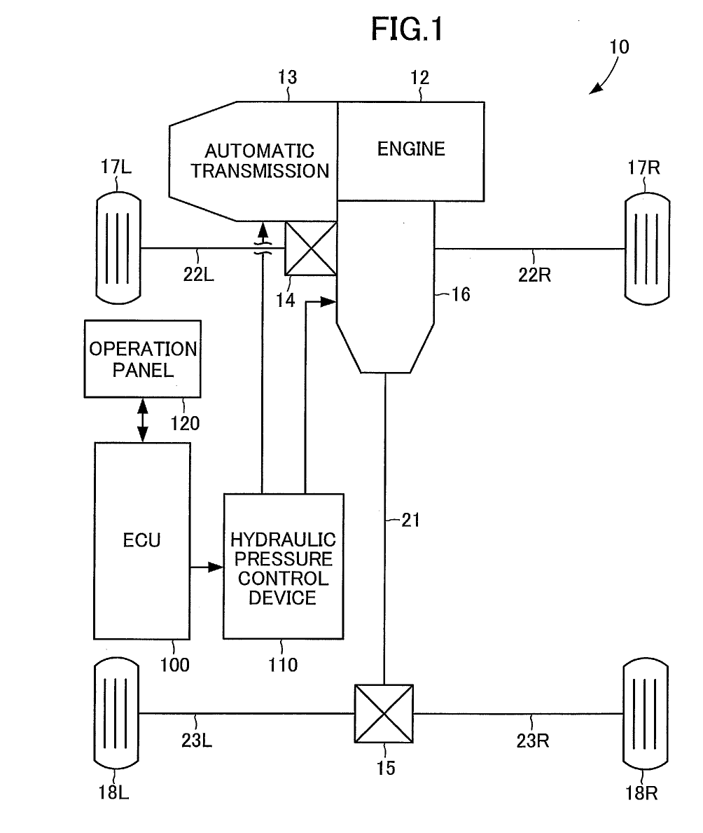

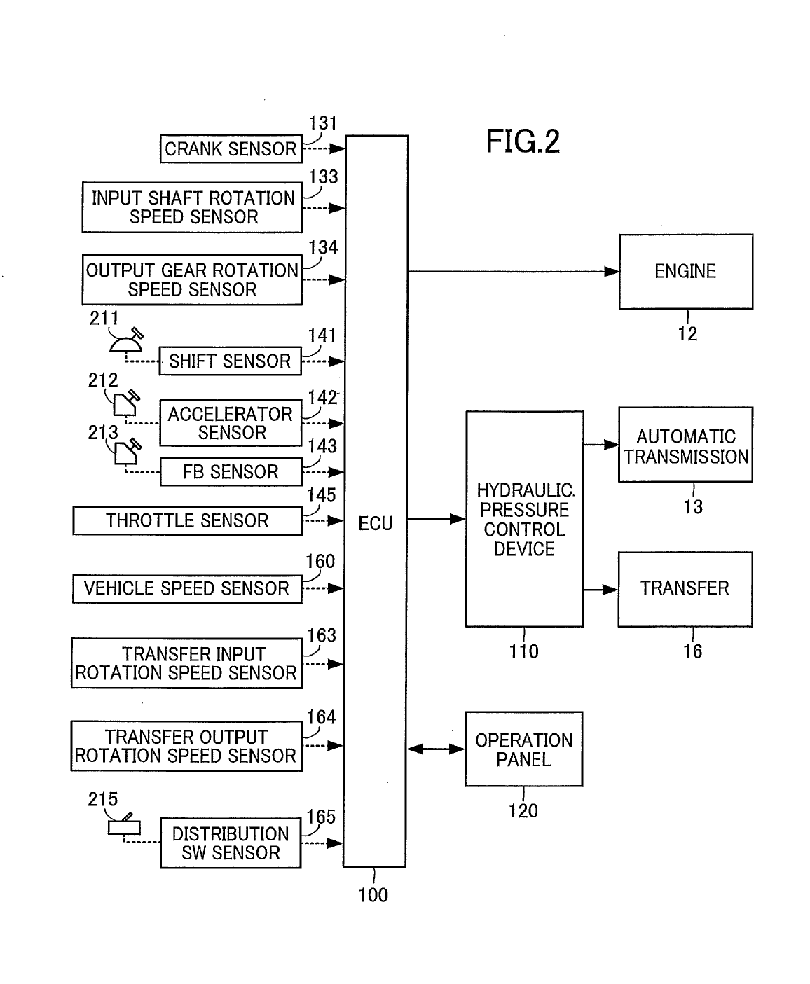

First, the construction of a vehicle having a control apparatus according to the first embodiment of the present invention will be described with reference to the schematic block diagram of the vehicle shown in FIG. 1 and the schematic block diagram of the vehicle control shown in FIG. 2.

As shown in FIG. 1, a vehicle 10 according to the present embodiment comprises an engine 12 serving as a power source, an automatic transmission 13 that transmits a torque generated by the engine 12 and forms transmission stages corresponding to the travel conditions of the vehicle 10, a front differential mechanism 14 that distributes the torque transmitted from the automatic transmission 13 to left and right front drive shafts 22L, 22R, a rear differential mechanism 15 that distributes the torque transmitted by a propeller shaft 21 to left and right rear drive shafts 23L, 23R, and a transfer 16 that distributes the torque transmitted by the automatic transmission 13 to front wheels 17L, 17R and rear wheels 18L, 18R.

Further, the vehicle 10 comprises an ECU (Electronic Control Unit) 100 serving as a vehicle electronic control unit that controls the entire vehicle 10, a hydraulic pressure control device 110 that hydraulically controls the automatic transmission 13 and the transfer 16, and an operation panel 120 serving as an input/output interface with the driver.

Further, as shown in FIG. 2, the vehicle 10 is provided with a crank sensor 131, an input shaft rotation speed sensor 133, an output gear rotation speed sensor 134, a shift sensor 141, an accelerator sensor 142, a foot brake sensor 143 (hereinafter simply referred to as an “FB sensor”), a throttle sensor 145, a wheel rotation speed sensor 160, a transfer input rotation speed sensor 163, a transfer output rotation speed sensor 164, a distribution SW sensor 165, and the various kinds of other sensors not shown in FIG. 2. The previously mentioned sensors are adapted to output their detection signals to the ECU 100.

The vehicle, in general, does not have all the above mentioned sensors 131 to 165, and the vehicle according to the present invention does not necessarily have all the above mentioned sensors 131 to 165, either. For example, some sensors can be substituted by other sensors with similar functions, or some detected values by other sensors can be used for the similar controls. This means that the vehicle 10 may not be equipped with some sensors which can be substituted by other sensors. In the present embodiment, the vehicle having some sensors which are not equipped with in such a general vehicle is for explaining processes in a case of using such sensors.

The engine 12 is constituted by a known power device which can output torque by combusting a mixture of hydrocarbon fuel such as gasoline or diesel oil with air in a combustion chamber of a cylinder not shown. The engine 12 is operated to intermittently repeat the actions of taking in the air-fuel mixture into the combustion chamber of the cylinder, combusting the mixture in the cylinder, and discharging exhaust gas to the outside of the cylinder to reciprocate a piston in the cylinder to enable a crank shaft drivably coupled to the piston to be rotated, thereby transmitting the torque to the automatic transmission 13. The fuel to be used for the engine 12 may be an alcohol fuel including an alcohol such as ethanol.

The automatic transmission 13 includes a plurality of planetary gear devices each provided with a plurality of friction engagement elements constituted by clutches and brakes and operative to be selectively engaged or disengaged, thereby forming a plurality of transmission stages in response to the combination of the engagement and disengagement of the clutches and the brakes. The clutches and the brakes are constructed to be switched selectively into their engaged states or their disengaged states by the hydraulic pressure control device 110.

By this construction, the automatic transmission 13 functions as a staged transmission to reduce or increase the torque or rotation of the crank shaft of the engine 12 inputted as a driving force at a predetermined speed change ratio γ to be outputted to the front differential mechanism 14 and the transfer 16. This means that the automatic transmission 13 constitutes a plurality of speed change stages operable in response to the vehicle travel states and thus can carry out a speed conversion in response to the speed change stages. The detailed explanation about the automatic transmission 13 will be described later. The automatic transmission 13 may be composed of a continuously variable transmission by continuously changing the transmission speed change ratio.

The front differential mechanism 14 is operative to allow the rotation speed to be different between the front wheels 17R and 17L when the vehicle is travelling on a curved road. The front differential mechanism 14 comprises a plurality of gears to distribute and output the torque inputted by the automatic transmission 13 to the front drive shafts 22L, 22R. The front differential mechanism 14 may be constructed to have the front drive shafts 22L, 22R rotated at the same rotation speed, and thus may be operated under a differential lock state having no difference in rotation speed between the front wheels 17L, 17R. The detailed explanation about the front differential mechanism 14 will be described hereinafter.

The rear differential mechanism 15 is substantially the same in construction as the front differential mechanism 14, so that the explanation about the rear differential mechanism 15 will be omitted.

The transfer 16, also known as an auxiliary transmission, serves to distribute and transmit the torque transmitted by the automatic transmission 13 to the front differential mechanism 14 and the rear differential mechanism 15. This means that the torque transmitted by the automatic transmission 13 can be distributed and transmitted by the transfer 16 to the front wheels 17L, 17R and the rear wheels 18L, 18R.

The vehicle 10 in the present embodiment is exemplified as a front-wheel driving vehicle at the time of a usual drive state in which the front wheels 17L, 17R serve as the driving wheels, respectively, when a four-wheel drive state is not selected. The transfer 16 is operative in the usual drive state and the four-wheel drive state as described hereinafter. This means that the transfer 16 can be operated at the usual drive state to transmit the torque transmitted by the automatic transmission 13 not to the rear differential mechanism 15 but only to the front differential mechanism 14. Further, the transfer 16 can be operated at the four-wheel drive state to transmit the torque transmitted by the automatic transmission 13 also to the rear differential mechanism 15, viz., can be operated to distribute and transmit the torque transmitted by the automatic transmission 13 to the front differential mechanism 14 and the rear differential mechanism 15. The detailed description about the transfer 16 will become apparent as the description proceeds.

The ECU 100 comprises a CPU (Central Processing Unit) as a central processing unit, a ROM (Read Only Memory) for storing therein fixed data, a RAM (Random Access Memory) for storing data therein temporarily, an EEPROM (Electrically Erasable and Programmable Read Only Memory) made of a rewritable non-volatile memory, and an I/O interface circuit, and is designed to carry out the overall control of the vehicle 10.

As will be stated below, the ECU 100 is connected to the crank sensor 131, the accelerator sensor 142, and the other sensors. The ECU 100 is adapted to receive detection signals outputted from these sensors to detect an engine rotation speed Ne, an accelerator opening degree Acc, and others.

Further, the ECU 100 is adapted to control the hydraulic pressure control device 110 which can control the hydraulic pressure for the parts of the automatic transmission 13 and the transfer 16. However, the characteristic functions of the ECU 100 will be described hereinafter.

In addition, the ROM of the ECU 100 is adapted to store therein an operation table to be used for realizing the transmission stages, and a program for performing the vehicle control as described hereinafter. Further, the ROM of the ECU 100 is adapted to store therein a throttle opening degree control map, a gear shifting diagram, a lock-up control map, and various other values of the vehicle 10 which will not be described in detail hereafter.

Furthermore, the ROM of the ECU 100 is adapted to store therein an accelerator pedal depression determination value Acc_tv, an accelerator threshold value Acc_th, a vehicle speed threshold value V_th, a deceleration threshold value map, deceleration threshold value calculation formulae, an output reducing accelerator opening degree Acn, and the like as necessary.

The accelerator pedal depression determination value Acc_tv is indicative of a determination value that determines whether the vehicle 10 is in an accelerator-on state or in an accelerator-off state in response to the depression amount of an accelerator pedal 212. The accelerator threshold value Acc_th is indicative of a threshold value that determines whether or not the control permission condition is established in response to the accelerator opening degree Acc when both of the accelerator pedal 212 and the foot brake pedal 213 are depressed. More specifically, when both of the accelerator pedal 212 and the foot brake pedal 213 are depressed, the vehicle 10 is stable and a heavy load is not applied to the driving system in the case that the accelerator opening degree Acc is small, even if the reduction control of the engine 12 is not executed. For this reason, the control permission condition is assumed not to be established when the accelerator opening degree Acc is smaller than or equal to the accelerator threshold value Acc_th. Here, the control permission condition means the condition for permitting the reduction control of the engine 12.

The vehicle speed threshold value V_th is, similar to the accelerator threshold value Acc_th, indicative of a threshold value that determines whether or not the control permission condition is established in response to a vehicle speed V when both of the accelerator pedal 212 and the foot brake pedal 213 are depressed. More specifically, when both of the accelerator pedal 212 and the foot brake pedal 213 are depressed, the vehicle 10 is stable and a heavy load is not applied to the driving system in the case that the vehicle speed V is small, even if the reduction control of the engine 12 is not executed. For this reason, the control permission condition is assumed not to be established when the vehicle speed V is smaller than or equal to the vehicle speed threshold value V_th.

The deceleration threshold value map is a map that determines the deceleration threshold value in response to the vehicle speed V and the accelerator opening degree Acc of the vehicle 10. More specifically, the deceleration threshold value map is a two dimensional table having the deceleration threshold value set for each of the predetermined values of the vehicle speed V and the accelerator opening degree Acc. The deceleration threshold value is indicative of a determination value of an acceleration αr that determines whether or not the vehicle 10 is in deceleration state. The acceleration αr, which will be described hereinafter, is calculated by the ECU 100 with a time variation of a vehicle speed V detected by the vehicle speed sensor 160.

The ECU 100 is adapted to determine the deceleration threshold value, the from the detected vehicle speed V and the accelerator opening degree Acc on the basis of the deceleration threshold value map. If the detected vehicle speed V and the accelerator opening degree Acc have values which are not set in the deceleration threshold value map, the ECU 100 is adapted to determine the deceleration threshold value, for example, by interpolating the values with linear conversion from other values set in the deceleration threshold value map.

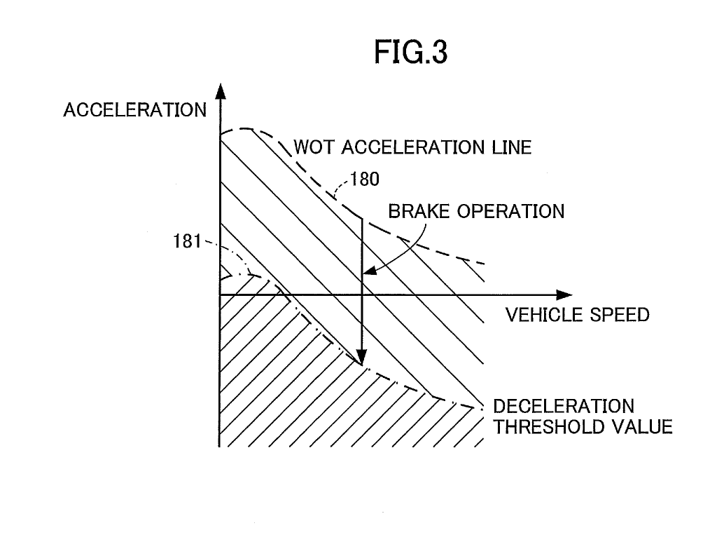

The ECU 100 is adapted to determine that the vehicle 10 is in the deceleration state if the acceleration αr is smaller than or equal to the determined deceleration threshold value, and to determine that the vehicle 10 is not in the deceleration state if the acceleration αr is larger than the determined deceleration threshold value. FIG. 3 is a graph showing the deceleration threshold values set by the deceleration threshold value map in the case that the accelerator opening degree Acc is the maximum. Hereinafter, WOT (Wide Open Throttle) means that the accelerator opening degree Acc is the maximum.

The deceleration threshold value calculation formula is assumed to be a calculation formula in the case that the deceleration threshold value is calculated in response to the vehicle speed V and the accelerator opening degree Acc of the vehicle 10. For example, the deceleration threshold value calculation formula that calculates the deceleration threshold value is a formula that represents a one-dot chain line 181 indicating the deceleration threshold values shown in FIG. 3. In addition, a dashed line 180 is indicative of the acceleration αr at the vehicle speed V in the case that a foot brake pedal 213 is not depressed in the WOT state.

The ECU 100 has to store in the ROM either one of the deceleration threshold value map or the deceleration threshold value calculation formula. The ECU 100 may have the deceleration threshold value set by the deceleration threshold value map different from the deceleration threshold value set by the deceleration threshold value calculation formula. The ECU 100 may further have both of the deceleration threshold value map and the deceleration threshold value calculation formula to select one of them in response to the conditions of drive state and the like.

The output reducing accelerator opening degree Acn is assumed to be an accelerator opening degree set for reducing the output of the engine 12 from an actual accelerator opening degree Acc when the control permission condition described later is established. The output reducing accelerator opening degree Acn may also be calculated in response to the drive state of the vehicle 10.

The hydraulic pressure control device 110 comprises linear solenoid valves SLT, SLU, an on-off solenoid valve SL, and linear solenoid valves SL1 to SL5, each of which is constituted by an electromagnetic valve to be controlled by the ECU 100. The hydraulic pressure control device 110 is adapted to be controlled by the ECU 100 to operate the above solenoid valves, so that the hydraulic circuit is switched and hydraulically controlled to operate the whole parts of the automatic transmission 13. Therefore, the hydraulic pressure control device 110 is adapted to control the solenoid valves so that the solenoid valves can be switched to establish a desired transmission stage in the automatic transmission 13.

The operation panel 120 is operably connected with the ECU 100 to receive operational requests inputted by the driver, to perform operational assistances to the driver, and to display vehicle travel states and others. For example, when the driver inputs one of the travel modes using switches and the like provided on the operation panel 120, the I/O interface of the ECU 100 is inputted with the signal indicative of the travel mode inputted by the driver.

The crank sensor 131 is adapted to detect the rotation speed of a crank shaft 24 and to output a detection signal indicative of the detected rotation speed to the ECU 100 under the control of the ECU 100. The ECU 100 is adapted to obtain as an engine rotation speed Ne the rotation speed of the crank shaft 24 indicated by the detection signal outputted by the crank sensor 131.

The input shaft rotation speed sensor 133 is adapted to detect the rotation speed of an input shaft 71 described below and to output a detection signal indicative of the detected rotation speed to the ECU 100 under the control of the ECU 100. The input shaft 71 is directly connected with a turbine shaft 62 of a torque converter 60 described later. The input shaft 71 has a rotation speed the same as the rotation speed of the turbine shaft 62, so that an input shaft rotation speed Nm detected by the input shaft rotation speed sensor 133 is represented as a turbine rotation speed Nt.

The output gear rotation speed sensor 134 is adapted to detect the rotation speed of an output gear 72 described later and to output a detection signal indicative of the detected rotation speed to the ECU 100 under the control of the ECU 100.

In addition, the ECU 100 is adapted to be capable of calculating a speed change ratio γ on the basis of a transmission input shaft rotation speed Nm detected by the input shaft rotation speed sensor 133 and a transmission output rotation speed Nc detected by the output gear rotation speed sensor 134. Here, the “speed change ratio γ” is obtained by dividing the actual rotation speed Nm of the input shaft 71 by the actual rotation speed Nc of the output gear 72.

The shift sensor 141 is adapted to detect any one of switched positions taken by the shift lever 211 among the switched positions taken by the shift lever 211 and to output a detection signal indicative of the switched position taken by the shift lever 211 to the ECU 100 under the control of the ECU 100.

Here, the shift lever 211 is constructed to take, from the rear side to the forward side of the vehicle 10, a D position indicative of a driving range (hereinafter simply referred to as a “D range”), an N position indicative of a neutral range, an R position indicative of a reverse range, and a P position indicative of a parking range.

If the shift lever 211 is located in the D range, a transmission mechanism 70 described below can establish any one of the speed stages from among the first to sixth speed stages. In this way, the ECU 100 can select any one of the speed stages from among the first to sixth speed stages on the basis of the vehicle speed V and a throttle opening degree θth as will be described hereinafter.

The accelerator sensor 142 is under the control of the ECU 100, and adapted to detect the accelerator pedal depression amount (hereinafter simply referred to as a “stroke”) and to output a detection signal indicative of the detected stroke to the ECU 100 when the accelerator pedal 212 is depressed. In addition, the ECU 100 is adapted to calculate the accelerator opening degree Acc from the stroke of the accelerator pedal 212 indicated by the detection signal outputted from the accelerator sensor 142.

Therefore, the accelerator sensor 142 is adapted to detect the drive state of the vehicle 10 including the torque demand of the torque outputted from the engine 12. This means that the accelerator sensor 142 constitutes the drive state detection unit. The accelerator sensor 142 is adapted to detect the depression of the accelerator pedal 212. In addition, the accelerator sensor 142 is adapted to detect the depression amount of the accelerator pedal 212. This means that the accelerator sensor 142 constitutes an accelerator detection unit.

The FB sensor 143 is adapted to detect whether or not the foot brake pedal 213 is depressed and to output the detection signal to the ECU 100 under the control of the ECU 100.

This means that the FB sensor 143 is adapted to detect the drive state of the vehicle 10. In other words, the FB sensor 143 constitutes the drive state detection unit. In addition, the FB sensor 143 is adapted to detect the depression of the foot brake pedal 213. In other words, the FB sensor 143 constitutes a brake detection unit.

The throttle sensor 145 is adapted to detect the opening degree of a throttle valve of the engine 12 driven by a throttle actuator not shown and to output a detection signal indicative of the detected opening degree to the ECU 100 under the control of the ECU 100. The ECU 100 is adapted to obtain as a throttle opening degree θth the throttle valve opening degree indicated by the detection signal outputted from the throttle sensor 145.

The vehicle speed sensor 160 is adapted to detect a rotation speed of a front drive shaft 22L or a front drive shaft 22R and to output detection signal indicative of the detected rotation speed to the ECU 100 under the control of the ECU 100. Further, the ECU 100 is adapted to obtain as a driving shaft rotation speed Nd the rotation speed of the front drive shaft 22L or the front drive shaft 22R indicated by the detection signal outputted from the vehicle speed sensor 160.

The ECU 100 is further adapted to calculate the vehicle speed V based on the driving shaft rotation speed Nd obtained from the vehicle speed sensor 160. The vehicle speed sensor 160 is therefore adapted to detect the drive state of the vehicle 10. This means that the vehicle speed sensor 160 constitutes the drive state detection unit. The vehicle speed sensor 160 is further adapted to detect the vehicle speed V of the vehicle 10. This means that the vehicle speed sensor 160 constitutes the vehicle speed detection unit.

The vehicle speed sensor 160 may be adapted to detect a rotation speed of the output gear 72 in lieu of the front drive shaft 22L or the front drive shaft 22R, and to calculate the vehicle speed V based on the rotation speed of the output gear 72. This means that the vehicle speed sensor 160 can be substituted by the output gear rotation speed sensor 134.

The ECU 100 is further adapted to calculate the acceleration αr of the vehicle 10 based from the time variation of the vehicle speed V calculated with the detected values of the vehicle speed sensor 160. The vehicle 10 may be separately provided with an acceleration sensor to detect the acceleration αr with the values detected by the acceleration sensor.

The transfer input rotation speed sensor 163 is under the control of the ECU 100, and adapted to detect a rotation speed TRin of the input shaft of the transfer 16 and to output a detection signal indicative of the detected rotation speed to the ECU 100. More specifically, the ECU 100 is adapted to detect the rotation speed of an input shaft 54 of a transfer clutch 53 as will become more apparent hereinafter.

The transfer output rotation speed sensor 164 is under the control of the ECU 100, and adapted to detect a rotation speed TRout of an output shaft of the transfer 16, and to output a detection signal indicative of the detected rotation speed to the ECU 100. More specifically, the ECU 100 is adapted to detect the rotation speed of the propeller shaft 21.

The distribution SW sensor 165 is under the control of the ECU 100, and adapted to detect whether a power changing switch 215 assumes a two-wheel drive selection position or a four-wheel drive selection position, and to output a detection signal indicative of the changed position of the power changing switch 215 to the ECU 100. To select the four-wheel drive and to select a low gear for a transfer gear by the power changing switch 215 is referred to as a L4-SW selection hereinafter. The power changing switch 215 may be constructed to be able to select a distribution ratio of the driving forces of the front wheels 17L, 17R and the rear wheels 18L, 18R in lieu of the alternative selection of the two-wheel drive selection position or the four-wheel drive selection position.

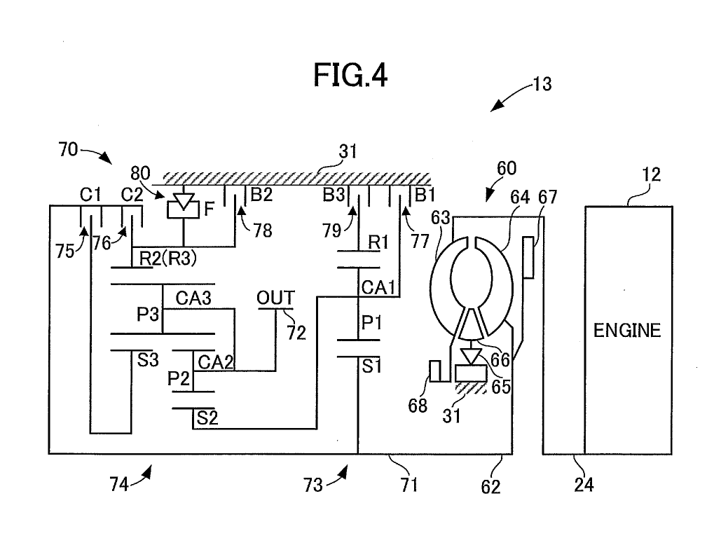

Next, the construction of the automatic transmission 13 in the present embodiment will be described with reference to the schematic block diagram shown in FIG. 4.

As shown in FIG. 4, the automatic transmission 13 comprises a torque converter 60 that transmits the torque outputted by the engine 12, and a transmission mechanism 70 that conducts the speed changes between the rotation speed of the input shaft 71 serving as an input shaft and the rotation speed of the output gear 72 serving as an output gear.

Between the transmission mechanism 70 and the front differential mechanism 14 is generally provided a reduction gear mechanism having the torque inputted by the transmission mechanism 70 to output the torque to the front differential mechanism 14 while reducing the rotation speed and increasing the driving force. For simplifying the explanation hereinafter, the vehicle 10 in the present embodiment will be described as being designed to directly transmit the torque to the front differential mechanism 14 from the transmission mechanism 70 without providing such a reduction gear mechanism.

The torque converter 60 is arranged between the engine 12 and the transmission mechanism 70, and comprises a pump impeller 63 inputted with the torque from the engine 12, a turbine runner 64 outputting the torque to the transmission mechanism 70, a stator 66 that changes the flow direction of oil, and a lock-up clutch 67 that directly connects the pump impeller 63 with the turbine runner 64, so that the torque can be transmitted through the oil.

The pump impeller 63 is connected to the crank shaft 24 of the engine 12. The pump impeller 63 is designed to be rotated integrally with the crank shaft 24 by the torque of the engine 12.

The turbine runner 64 is connected to the turbine shaft 62 which is in turn connected to the transmission mechanism 70. The turbine shaft 62 is directly connected to the input shaft 71 of the transmission mechanism 70. The turbine runner 64 is rotated by the flow of the oil pushed by the rotation of the pump impeller 63, and designed to output to the transmission mechanism 70 the rotation of the crank shaft 24 of the engine 12 through the turbine shaft 62.

The stator 66 is rotatably supported through a one-way clutch 65 by a housing 31 of the automatic transmission 13 constituting a non-rotating member. The stator 66 serves to change the directions in flow of the oil from the turbine runner 64 and into the pump impeller 63 to generate a force to turn the pump impeller 63. The stator 66 is prevented from rotating by the one-way clutch 65 to change the direction of the oil flowing in the stator 66.

The stator 66 idles away to prevent a reverse torque from being applied to the turbine runner 64 when the pump impeller 63 and the turbine runner 64 come to be rotated at almost the same rotation speed.

The lock-up clutch 67 is constructed to directly connect the pump impeller 63 and the turbine runner 64 to have the rotation of the crank shaft 24 of engine 12 mechanically transmitted directly to the turbine shaft 62.

Here, the torque converter 60 is adapted to transmit the torque through the oil between the pump impeller 63 and the turbine runner 64. Therefore, the rotation of the pump impeller 63 cannot transmit the torque by 100% to the turbine runner 64. For this reason, when the speeds of the turbine shaft 62 and the crank shaft 24 become close to each other, the lock-up clutch 67 is operated to mechanically connect the pump impeller 63 and the turbine runner 64 directly, more particularly, to mechanically directly connect the crank shaft 24 to the turbine shaft 62 for more efficient transmission to the transmission mechanism 70 from the engine 12, thereby resulting in improving the fuel efficiency.

The lock-up clutch 67 is constructed to be able to realize a flex lock-up causing a slip at a predetermined slip ratio. The state of the lock-up clutch 67 is adapted to be selected by the CPU of the ECU 100 in response to the travel state of the vehicle 10, more specifically, the vehicle speed V and the accelerator opening degree Acc based on the lock-up control map stored in the ROM of the ECU 100. In addition, the state of the lock-up clutch 67 can, as described above, assume one of three states, viz., a converter state having the lock-up clutch 67 released, a lock-up state having the lock-up clutch 67 coupled, and a flex lock-up state having the lock-up clutch 67 slipped.

In addition, the pump impeller 63 is provided with a mechanical type of oil pump 68 that generates hydraulic pressure used for performing the transmission action of the transmission mechanism 70, and for supplying the oil to activate, lubricate and cool parts and elements.

The transmission mechanism 70 comprises, in addition to the input shaft 71 and the output gear 72, a first planetary gear 73, a second planetary gear 74, a C1 clutch 75, a C2 clutch 76, a B1 brake 77, a B2 brake 78, a B3 brake 79, and an F one-way clutch 80.

The input shaft 71 is directly connected to the turbine shaft 62 of the torque converter 60 so that the input shaft 71 can be directly inputted with the outputted rotation of the torque converter 60. The output gear 72 is connected with a carrier of the second planetary gear 74 and is held in engagement with a differential ring gear 42 of the front differential mechanism 14 as will be described hereinafter, so that the output gear 72 can function as a counter drive gear. This means that the output gear 72 is adapted to transmit the outputted rotation of the transmission mechanism 70 to the front differential mechanism 14.

The first planetary gear 73 is constituted by a single pinion type of planetary gear mechanism. The first planetary gear 73 comprises a sun gear S1, a ring gear R1, a pinion gear P1, and a carrier CA1.

The sun gear S1 is coupled to the input shaft 71. The sun gear S1 is connected to the turbine shaft 62 of the torque converter 60 through the input shaft 71. The ring gear R1 is selectively fixed to the housing 31 of the automatic transmission 13 through the B3 brake 79.

The pinion gear P1 is rotatably supported by the carrier CA1. The pinion gear P1 is held in mesh with the sun gear S1 and the ring gear R1. The carrier CA1 is selectively fixed to the housing 31 of the automatic transmission 13 through the B1 brake 77.

The second planetary gear 74 is constituted by a ravigneaux type of planetary gear mechanism. The second planetary gear 74 comprises a sun gear S2, ring gears R2, R3, a short pinion gear P2, a long pinion gear P3, a sun gear S3, a carrier CA2, and a carrier CA3.

The sun gear S2 is connected with the carrier CA1 of the first planetary gear 73. The ring gears R2, R3 are selectively connected to the input shaft 71 through the C2 clutch 76. The ring gears R2, R3 are selectively fixed to the housing 31 through the B2 brake 78. The ring gears R2, R3 are blocked in rotation in a rotation direction opposite to the rotation direction of the input shaft 71 (hereinafter simply referred to as an “opposite direction”) by the F one-way clutch 80 provided in parallel with the B2 brake 78.

The short pinion gear P2 is rotatably supported by the carrier CA2. The short pinion gear P2 is held in mesh with the sun gear S2 and the long pinion gear P3. The long pinion gear P3 is rotatably supported by the carrier CA3. The long pinion gear P3 is held in mesh with the short pinion gear P2, the sun gear S3, and the ring gears R2, R3.

The sun gear S3 is selectively connected with the input shaft 71 through the C1 clutch 75. The carrier CA2 is connected with the output gear 72. The carrier CA3 is connected to the carrier CA2 and the output gear 72.

In addition, the B1 brake 77, the B2 brake 78, and the B3 brake 79 are fixed to the housing 31 of the automatic transmission housing 13. The C1 clutch 75, the C2 clutch 76, the F one-way clutch 80, the B1 brake 77, the B2 brake 78, and the B3 brake 79 (hereinafter simply referred to as a “clutch C” and “brake B”, respectively, as long as the above clutches and the above brakes are particularly not needed to be distinguished) are each constituted by a hydraulic type of friction engagement device having a multi-plate type of clutch or brake hydraulically activated and controlled by a hydraulic actuator. The clutch C and the brake B are changeable to assume the engagement state from the disengagement state, and vice versa, through the hydraulic circuit to be changed by the energization or de-energization of the linear solenoid valves SL1 to SL5, SLU, SLT, and the on-off solenoid valve SL of the hydraulic control device 110 and to be changed by the operation state of the manual valve not shown.

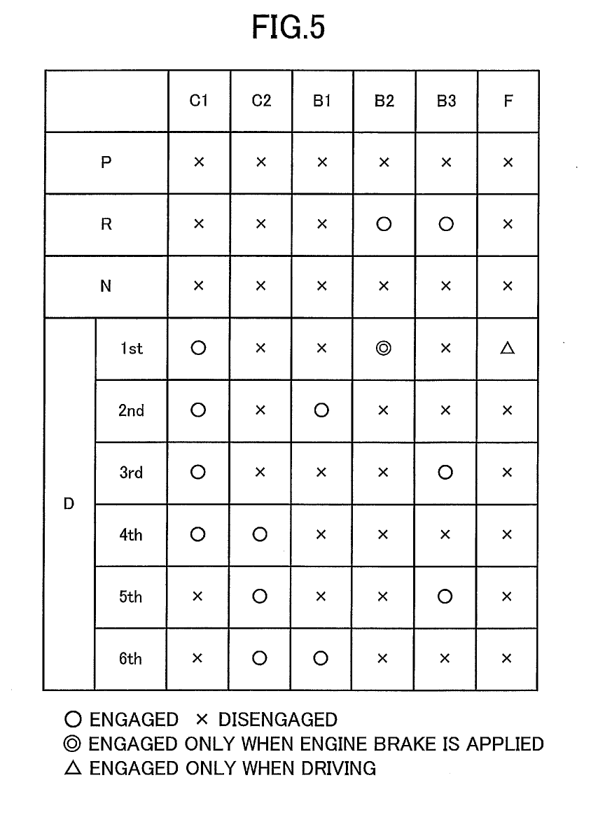

Next, the transmission mechanism 70 of the automatic transmission 13 in the present embodiment will be explained hereinafter with reference to the operation table shown in FIG. 5 while focusing on the engagement state of the frictional engagement elements to realize each of the transmission stages.

As shown in FIG. 5, the operation table to be used for realizing each of the transmission stages shows the engagement and disengagement states to be assumed by each of the frictional engagement elements of the transmission mechanism 70, viz., the clutches C and the brakes B to realize each of the transmission stages. In FIG. 5, the mark “◯” (circle) is representative of the engagement, and the mark “X” (cross) is representative of the disengagement. The mark “⊚” (double circle) is representative of the engagement only at the time of applying an engine brake, and the mark “Δ” (triangle) is representative of the engagement only at the time of driving the vehicle 10.

On the basis of the combination of the engagement and disengagement shown in the operation table, each of the frictional engagement elements are operated by the energization and de-energization or the electric current control of the linear solenoid valves SL1 to SL5 provided in the hydraulic control device 110 (see FIG. 1) and the transmission solenoids not shown to establish the first to sixth stages of the forward speed change stages and the rearward speed change stage.

On the basis of the operation table, the ECU 100 is adapted to engage the F one-way clutch 80 in addition to the engagement of the C1 clutch 75 at the time of driving the vehicle 10, for example, in the case of realizing the first speed state. Further, the ECU 100 is adapted to engage the B2 brake 78 in addition to the C1 clutch 75 at the time of applying the engine brake in the case of realizing the first speed state.

For realizing the rearward speed change stage, the ECU 100 is adapted to engage the B2 brake 78 and the B3 brake 79. Further, for realizing the neutral range and the parking range, the ECU 100 is adapted to disengage all of the C1 clutch 75, the C2 clutch 76, the B1 brake 77, the B2 brake 78, the B3 brake 79, and the F one-way clutch 80. In this way, all of the disengagements of the frictional engagement elements of the transmission mechanism 70 cause the neutral state with no torque transmission between the input side and the output side to be established.

Next, the function about each of the solenoid valves of the hydraulic control device 110 will be explained hereinafter. The linear solenoid valve SLT is adapted to perform the hydraulic control of the line pressure PL serving as an original hydraulic pressure of the oil to be supplied to the parts and the elements. More specifically, the linear solenoid valve SLT is controlled by the ECU 100 to adjust the line pressure PL on the basis of the throttle opening degree θth, an intake air amount Qar of the engine 12, a temperature Tw of the cooling water of the engine 12, the rotation speed Ne of the engine 12, the rotation speed Nm of the input shaft, viz., the rotation speed Nt of the turbine, a temperature Tf of the oil in the automatic transmission 13 and the hydraulic control device 110, shift positions Psh, shift ranges, and other factors.

The linear solenoid valve SLU is adapted to perform the lock-up control of the torque converter 60. More specifically, the linear solenoid valve SLU is controlled by the ECU 100 on the basis of the engine rotation speed Ne indicative of the input rotation speed of the torque converter 60, the turbine rotation speed Nt indicative of the output rotation speed of the torque converter 60, the throttle opening degree θth, the vehicle speed V, the input torque, and other factors to adjust the pressure of a lock-up relay valve and a lock-up control valve not shown in the drawings to control the lock-up clutch 67. The on-off solenoid valve SL is adapted to perform the changing operation of the hydraulic pressure of the lock-up relay valve.

The linear solenoid valves SL1 to SL5 serve to perform the speed change control. The linear solenoid valves SL1 and SL2 function to hydraulically control the C1 clutch 75 and the C2 clutch 76. The linear solenoid valves SL3, SL4 and SL5 are designed to hydraulically control the B1 brake 77, the B2 brake 78, and the B3 brake 79.

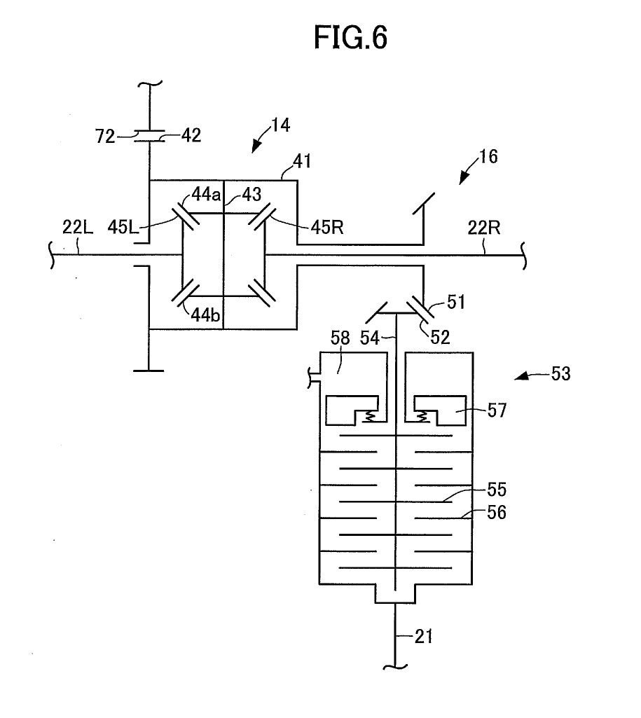

The constructions of the front differential mechanism 14 and the transfer 16 in the present embodiment will be explained hereinafter with reference to the schematic block diagram shown in FIG. 6.

As shown in FIG. 6, the front differential mechanism 14 comprises a hollow differential gear case 41, a differential ring gear 42 provided on the outer peripheral portion of the differential gear case 41, a pinion shaft 43 provided in the differential gear case 41, differential pinion gears 44a, 44b, and side gears 45L, 45R. Further, the differential pinion gears 44a, 44b, and the side gears 45L, 45R are each constituted by a bevel gear.

The differential gear case 41 is rotatably supported on and around the front drive shafts 22L, 22R. The differential ring gear 42 is provided on the outer peripheral portion of the differential gear case 41, and in engagement with the output gear 72 of the automatic transmission 13. The pinion shaft 43 is in parallel with the differential ring gear 42 and secured to the differential gear case 41, so that the pinion shaft 43 is rotated integrally with the differential gear case 41.

The differential pinion gears 44a, 44b are rotatably supported on and around the pinion shaft 43. The side gear 45L is securely mounted on and rotated integrally with the front drive shaft 22L, and is held in meshing engagement with the differential pinion gear 44a and the differential pinion gear 44b. In a similar manner, the side gear 45R is securely mounted on and rotated integrally with the front drive shaft 22R, and is held in meshing engagement with the differential pinion gear 44a and the differential pinion gear 44b.

It is thus to be noted that the front differential mechanism 14 is constructed to have the side gear 45L and the side gear 44R rotated together when the differential pinion gear 44a and the differential pinion gear 44b are not rotated. On the other hand, the front differential mechanism 14 is constructed to have the side gear 45L and the side gear 44R relatively rotated in their opposite directions when the differential pinion gears 44a, 44b are rotated. It is therefore understood that the front differential mechanism 14 is constructed to allow the rotation speed difference between the side gear 45L integrally rotated with the front drive shaft 22L and the side gear 45R integrally rotated with the front drive shaft 22R, thereby making it possible to absorb the rotation speed difference between the front wheel 17L and the front wheel 17R when the vehicle is travelling on a curved road.

The rear differential mechanism 15 is the same in construction as the front differential mechanism 14, and thus will not be explained in detail hereinafter. The rear differential mechanism 15 has the differential ring gear 42 held in engagement with the pinion gear of the propeller shaft 21 in place of the output gear 72 of the automatic transmission 13. The rear differential mechanism 15 has the left and right side gears rotated integrally with the rear drive shafts 23L, 23R in lieu of the front drive shafts 22L, 22R.

The transfer 16 comprises a hypoid gear 51, a hypoid pinion 52, and a transfer clutch 53.

The hypoid gear 51 is integrally rotated with the differential gear case 41 of the front differential mechanism 14 to input the torque to the transfer 16 from the automatic transmission 13 through the front differential mechanism 14. The hypoid pinion 52 and the hypoid gear 51 are each constituted by a gear such as for example a bevel gear to change the rotation direction of the torque inputted from the hypoid gear 51 at an angle of 90 degrees.

The transfer clutch 53 comprises an input shaft 54, a plurality of multi-plate clutch discs 55, a plurality of multi-plate clutch plates 56, and a piston 57, and has a hydraulic servo chamber 58 formed therein. The transfer clutch 53 is constructed to have the hypoid pinion 52 and the propeller shaft 21 connected with each other to make it possible for the torque to be transmitted. The transfer clutch 53 itself is constructed by a known wet multi-plate clutch of a hydraulic servo type.

The input shaft 54 is drivably connected with the hypoid pinion 52 to be inputted with the torque from the hypoid pinion 52 and to output the torque to the multi-plate clutch discs 55. The multi-plate clutch plates 56 are constructed to transmit the torque to the propeller shaft 21. The multi-clutch discs 55 and the multi-plate clutch plates 56 collectively constitute a multi-plate clutch as defined in the present invention.

The hydraulic pressure in the hydraulic servo chamber 58 is controlled by the hydraulic control device, so that the hydraulic pressure fed into the hydraulic servo chamber 58 causes the multi-plate clutch discs 55 and the multi-plate clutch plates 56 to be pressed by the piston 57 at a predetermined pressure, thereby securing a predetermined amount of torque transmission therebetween.

The transfer 16 is constructed to distribute the driving force of the engine 12 to the front wheels 17L, 17R and the rear wheels 18L, 18R as understood from the previous description. This means that the transfer 16 constitutes a driving force distribution device.

The characteristic construction of the ECU 100 mounted on the vehicle 10 in the embodiment according to the present invention will be explained hereinafter.

The ECU 100 is adapted to execute the reduction control to reduce the torque outputted from the engine 12 for the amount of the torque demand. In addition, the ECU 100 is adapted to execute the reduction control in the case that a prerequisite for establishing a control permission condition permitting the execution of the reduction control is satisfied, the prerequisite being that the depression of the accelerator pedal 212 is detected by the accelerator sensor 142 and the depression of the brake pedal 213 is detected by the FB sensor 143, and a variation occurred by a travel state of the vehicle 10 detected by the accelerator sensor 142, the FB sensor 143, and the vehicle speed sensor 160 is estimated to be out of a preset protection range of the vehicle, on the other hand, the ECU 100 being adapted not to execute the reduction control in the case that the variation occurred by the travel state of the vehicle 10 detected by the accelerator sensor 142, the FB sensor 143, and the vehicle speed sensor 160 is estimated to be within the preset protection range of the vehicle 10 even if the prerequisite is satisfied.

The ECU 100 is further adapted to estimate that the variation occurred by the travel state of the vehicle 10 is within the protection range in the case that the depression amount of the accelerator pedal 212 detected by the accelerator sensor 142 is less than or equal to the accelerator threshold value. In addition, the ECU 100 is adapted to estimate that the variation occurred by the travel state of the vehicle 10 is within the protection range in the case that the vehicle speed V detected by the vehicle speed sensor 160 is smaller than or equal to the vehicle speed threshold value. For example, the ECU 100 is adapted to estimate that the variation occurred by the travel state of the vehicle 10 is within the protection range in the case that the depression amount of the accelerator pedal 212 detected by the accelerator sensor 142 is less than or equal to the accelerator threshold value and the vehicle speed V detected by the vehicle speed sensor 160 is smaller than or equal to the vehicle speed threshold value. This means that the ECU 100 constitutes the output control unit.

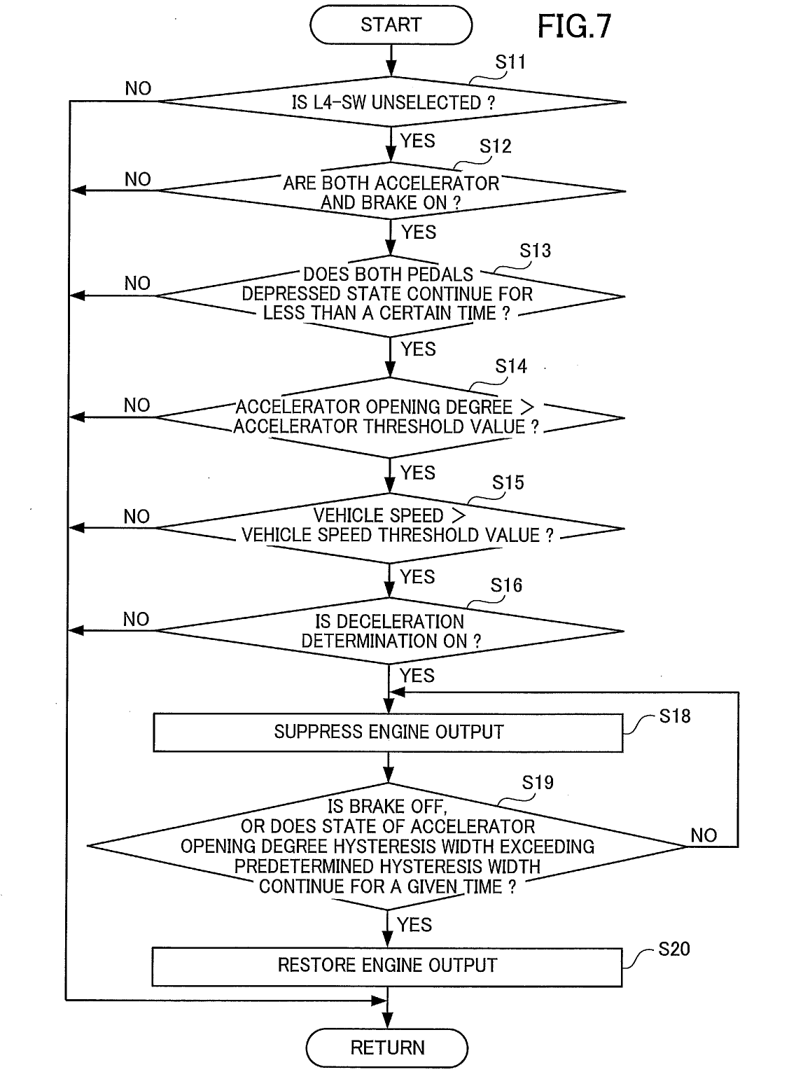

Next, the operation of the vehicle control process in the present embodiment will be described with reference to a flowchart shown in FIG. 7.

The flowchart shown in FIG. 7 represents an executing content of a program for vehicle control process to be executed by the CPU of the ECU 100 with the RAM as a work area. The program for the vehicle control process is stored in the ROM of the ECU 100. The vehicle control process is designed to be executed by the CPU of the ECU 100 at a predetermined interval.

As shown in FIG. 7, the ECU 100 is adapted to determine whether or not the L4-SW is unselected (Step S11).

The ECU 100 is adapted to finish the vehicle control process when the ECU 100 determines that the L4-SW is not unselected, viz., the L4-SW is selected (“NO” in Step S11), resulting from the fact that the reduced torque of the engine 12 tends to cause hesitation and the like, thereby deteriorating the drivability.

When, on the other hand, the ECU 100 determines that the L4-SW is unselected (“YES” in Step S11), the ECU 100 then determines whether or not both of the accelerator and the brake are “on” and finishes the vehicle control process if the accelerator or the brake is not “on” (Step S12). More specifically, the ECU 100 is adapted to determine whether or not the accelerator opening degree Acc detected by the accelerator sensor 142 is larger than or equal to the accelerator pedal depression determination value Acc_tv stored in the ROM. When the ECU 100 determines that the accelerator opening degree Acc is larger than or equal to the accelerator pedal depression determination value Acc_tv, the ECU 100 is adapted to determine that the accelerator pedal 212 is depressed, viz., the accelerator is “on”. When, on the other hand, the ECU 100 determines that the accelerator opening degree Ace is smaller than the accelerator pedal depression determination value Acc_tv, the ECU 100 is adapted to determine that the accelerator pedal 212 is not depressed, viz., the accelerator is “off”. In addition, the ECU 100 is adapted to determine whether the brake pedal 213 is depressed, viz., the brake is “on” or the brake pedal 213 is not depressed, viz., the brake is “off” by a detection signal detected by the FB sensor 143.

If the accelerator is “on” and the brake is “on” (“YES” in Step S12) when the ECU 100 determines whether or not both of the accelerator and the brake are “on” (Step S12), the ECU 100 starts a timer and monitors the duration of the accelerator and the brake being depressed together. Then, if the accelerator is “off” or the brake is “off” (“NO” in Step S12), the ECU 100 clears the timer of the duration of the accelerator and the brake being depressed together and finishes the monitoring.

If the accelerator is “on” and the brake is “on” (“YES” in Step S12), the ECU 100 is adapted to determine whether or not the state of the accelerator pedal and the brake pedal being depressed together continues for less than a certain time. When the ECU 100 determines that the state of the accelerator pedal and the brake pedal being depressed together continues for not less than the certain time, viz., the state of the accelerator pedal and the brake pedal being depressed together continues for equal to or more than the certain time, the ECU 100 is adapted to finish the vehicle control process (Step S13).

On the other hand, if the state of the accelerator pedal and the brake pedal being depressed together continues for less than a certain time (“YES” in Step S13), the ECU 100 is adapted to determine whether or not the acceleration opening degree Acc is larger than the accelerator threshold value Acc_th. When the ECU 100 determines that the acceleration opening degree Acc is not larger than the accelerator threshold value Acc_th, viz., the acceleration opening degree Acc is smaller than or equal to the accelerator threshold value Acc_th, the ECU 100 is adapted to finish the vehicle control process (Step S14).

If the acceleration opening degree Acc is larger than the accelerator threshold value Acc_th (“YES” in Step S14), the ECU 100 is adapted to determine whether or not the vehicle speed V is larger than the vehicle speed threshold value V_th. When the ECU 100 determines that the vehicle speed V is not larger than the vehicle speed threshold value V_th, viz., the vehicle speed V is smaller than or equal to the vehicle speed threshold value V_th, the ECU 100 is adapted to finish the vehicle control process (Step S15).

Next, when the ECU 100 determines that the vehicle speed V is larger than the vehicle speed threshold value V_th (“YES” in Step S15) the ECU 100 is adapted to execute a deceleration determination. If the deceleration determination is not “on”, viz., the deceleration determination is “off”, the ECU 100 is adapted to finish the vehicle control process (Step S16). The more specific explanation of a deceleration determination process will become apparent as the description proceeds hereinafter.

The ECU 100 is adapted to execute an engine output suppression process (Step S18), when the deceleration determination is “on” (“YES” in Step S16). For example, the ECU 100 is adapted to rewrite the accelerator opening degree value from an actual accelerator opening degree Acc to the output reducing accelerator opening degree Acn stored in the ROM to reduce the torque of the engine 12, so that the torque can be reduced smaller than the engine output by the actual accelerator opening degree Acc. Here, a reduction speed of an engine torque, i.e., a rate of the change from the actual accelerator opening degree Acc to the output reducing accelerator opening degree Acn can make a time to be reduced to a desired engine torque become a constant time by adjusting the rate of the change in response to the vehicle speed V.

Next, the ECU 100 is adapted to determine whether or not a termination condition of the engine output suppression process is established (Step S19). More specifically, the ECU 100 is adapted to determine whether or not the brake is “off” or a state of a hysteresis width of the accelerator opening degree exceeding a predetermined hysteresis width continues for a predetermined time. When the ECU 100 determines that the brake is “on” and the hysteresis width of the accelerator opening degree is smaller than or equal to the predetermined hysteresis width, or a predetermined time has not elapsed even if the hysteresis width of the accelerator opening exceeds the predetermined hysteresis width, the ECU 100 is adapted to return to the engine output suppression process (Step S18). Here, the hysteresis width of the accelerator opening degree is intended to indicate the difference between the actual accelerator opening degree Acc before the engine output suppression process (Step S18) and the current actual accelerator opening degree Acc detected by the accelerator sensor 142.

When the termination condition of the engine output suppression process is established, viz., the ECU 100 determines that the brake is “off”, or the state of the hysteresis width of the accelerator opening degree exceeding the predetermined hysteresis width continues for a predetermined time (“YES” in Step S19), the ECU 100 is adapted to perform the torque returning process of the engine 12, and to finish the vehicle control process (Step S20). For example, if the ECU 100 has rewritten the accelerator opening degree in the engine output suppression process (Step S18), the ECU 100 is adapted to return the accelerator opening degree to the actual accelerator opening degree Acc detected by the accelerator sensor 142, and to return the torque of the engine 12 to the torque at the time of normal travel state.

Next, the deceleration determination process (Step S16) will be explained in detail. The ECU 100 is, as described above, adapted to store in the ROM the deceleration threshold value map having the deceleration threshold value set in response to the accelerator opening degree Acc and the vehicle speed V.

The ECU 100 is, in the deceleration determination process, adapted to detect the vehicle speed V detected by the vehicle speed sensor 160, and to calculate the acceleration αr from the time variation of the vehicle speed V as described before. Next, the ECU 100 is adapted to determine the deceleration threshold value in response to the detection values of the accelerator opening degree Acc and the vehicle speed V. For example, if the accelerator opening degree is WOT, the ECU 100 is adapted to detect the deceleration threshold value at the vehicle speed V on the basis of the deceleration threshold value map shown in FIG. 3, and to determine the detected value as the deceleration threshold value.

Next, the ECU 100 is adapted to compare the calculated acceleration αr with the determined deceleration value. If the calculated acceleration αr is larger than the deceleration threshold value, the ECU 100 is adapted to determine that the vehicle is not in the deceleration state. If the calculated acceleration αr is smaller than or equal to the deceleration threshold value, the ECU 100 is adapted to determine that the vehicle is in the deceleration state.

As will be understood from the foregoing description, the vehicle control apparatus according to the present embodiment is adapted to determine that the control permission condition is not established, and not to execute the reduction control in the case that the variation occurred by the travel state of the vehicle is estimated to be within the preset protection range of the vehicle 10 even if the depression of the accelerator pedal 212 is detected and the depression of the brake pedal 213 is detected. Therefore, the vehicle control apparatus according to the present invention can stop the torque reduction control to prevent the reduction of the engine output contrary to the intention of the driver in the case that the impact to the vehicle is small such that the load more than necessary is not applied to the vehicle 10 even if the accelerator pedal and the brake pedal are both depressed by the driver. As a result, the vehicle control apparatus can improve the operability of the vehicle 10 in the situations such as hill start and overcoming steps, thereby preventing the drivability from being deteriorated.

The vehicle control apparatus according to the present embodiment is adapted to estimate the variation occurred by the travel state of the vehicle 10 is within the preset protection range in the case that the depression amount of the accelerator pedal 212 is smaller than or equal to the accelerator threshold value Acc_th. Therefore, the vehicle control apparatus according to the present invention is adapted to determine that the control permission condition is not established, and not to execute the reduction control when the depression amount of the accelerator pedal 212 is smaller than or equal to the accelerator threshold value Acc_th. As a result, the vehicle control apparatus can reflect the intention of the driver according to the accelerator pedal opening degree Acc to improve the operability of the vehicle 10, thereby preventing the drivability from being deteriorated.

The vehicle control apparatus according to the present embodiment is further adapted to estimate the variation occurred by the travel state of the vehicle 10 is within the preset protection range in the case that the vehicle speed V is smaller than or equal to the vehicle speed threshold value V_th. Therefore, the vehicle control apparatus according to the present invention is adapted to determine that the control permission condition is not established, and not to execute the reduction control when the vehicle speed V is smaller than or equal to the vehicle speed threshold value V_th. As a result, the vehicle control apparatus can reflect the intention of the driver according to the vehicle speed V to improve the operability of the vehicle 10, thereby preventing the drivability from being deteriorated.

### Second Embodiment

Next, the following explanation will be directed hereinafter to a vehicle control apparatus according to a second embodiment of the invention. The construction of the vehicle in the present embodiment is the same as that of the vehicle 10 in the first embodiment, and thus the constituent elements of the present embodiment the same as those of the first embodiment bear the reference numerals of the present embodiment the same as those of the first embodiment in the drawings. Accordingly, the detailed explanations about the constituent elements of the present embodiment the same as those of the first embodiment will be omitted hereinafter.

The vehicle control apparatus according to the present embodiment is adapted to estimate the variation occurred by the travel state of the vehicle 10 is within the preset protection range in the case that the accelerator opening degree Acc is smaller than or equal to the accelerator threshold value Acc_th and the vehicle speed V is smaller than or equal to the vehicle speed threshold value V_th. Therefore, the vehicle control apparatus according to the present invention is adapted to determine that the control permission condition is not established, and not to execute the reduction control.

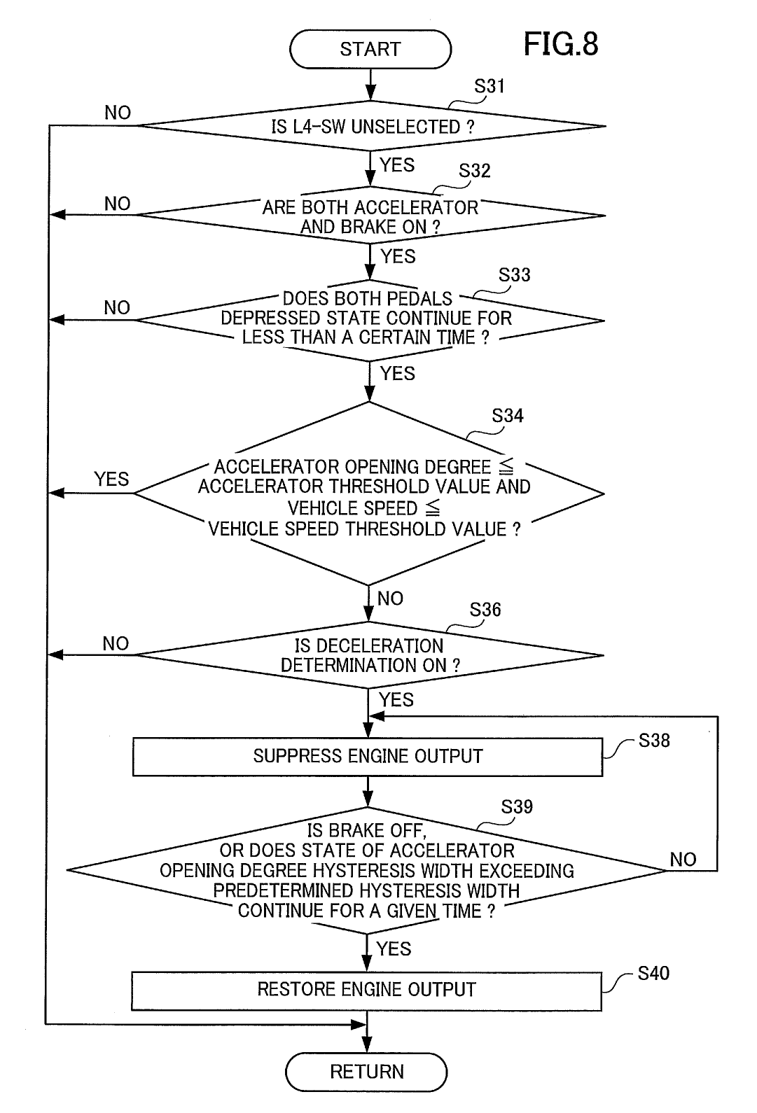

Next, the operation of the vehicle control process in the present embodiment will be described with reference to a flowchart shown in FIG. 8.

The flowchart shown in FIG. 8 represents an executing content of a program for vehicle control process to be executed by the CPU of the ECU 100 with the RAM as a work area. The program for the vehicle control process is stored in the ROM of the ECU 100. The vehicle control process is designed to be executed by the CPU of the ECU 100 at a predetermined interval.

The processes at Step S31 to Step S33 and Step S36 to Step S40 are the same as those at Step S11 to Step S13 and Step S16 to Step S20 in the first embodiment, respectively, and thus their detailed explanations are to be omitted hereinafter.

As shown in FIG. 8, the ECU 100 is adapted to determine that the L4-SW is unselected (“YES” in Step S31), and to determine that the accelerator and the brake are both on (“YES” in Step S32), and when the state of the accelerator pedal and the brake pedal being depressed together continues for less than a certain time (“YES” in Step S33), the ECU 100 is adapted to determine whether or not the accelerator opening degree Acc is smaller than or equal to the accelerator threshold value Acc_th and the vehicle speed V is smaller than or equal to the vehicle speed threshold value V_th (Step S34). If the accelerator opening degree Acc is smaller than or equal to the accelerator threshold value Acc_th and the vehicle speed V is smaller than or equal to the vehicle speed threshold value V_th (“YES” in Step S34), the ECU 100 is adapted to finish the vehicle control process.

On the other hand, the ECU 100 is adapted to execute the deceleration determination (Step S36), if the accelerator opening degree Acc is not smaller than and not equal to the accelerator threshold value Acc_th, viz., the accelerator opening degree Acc is larger than the accelerator threshold value Acc_th, or if the vehicle speed V is not smaller than and not equal to the vehicle speed threshold value V_th, viz., the vehicle speed V is larger than the vehicle speed threshold value V_th (“NO” in Step S34).

When the deceleration determination is “off” (“NO” in Step S36), the ECU 100 is adapted to finish the vehicle control process. On the other hand, when the deceleration determination is “on” (“YES” in Step S36), the ECU 100 is adapted to execute the engine output suppression process (Step S38), and to continue the process until the termination condition of the engine output suppression process is established. When the termination condition of the engine output suppression process is established (“YES” in Step S39), the ECU 100 is adapted to perform the torque returning process of the engine 12 (Step S40), and to finish the vehicle control process.

As will be understood from the foregoing description, the vehicle control apparatus according to the present embodiment is adapted to estimate the variation occurred by the travel state of the vehicle 10 is within the preset protection range in the case that the accelerator opening degree Acc is smaller than or equal to the accelerator opening degree threshold value Acc_th and the vehicle speed V is smaller than or equal to the vehicle speed threshold value V_th. Therefore, the vehicle control apparatus according to the present invention can determine that the control permission condition is not established not to execute the reduction control when the both conditions of the accelerator opening degree and the vehicle speed are satisfied. As a result, the vehicle control apparatus can strictly set non-execution conditions for the reduction control, thereby preventing the drivability from being deteriorated.

While the previously mentioned embodiments have been explained about the vehicle 10 with an engine 12 functioning as a power source using gasoline as a fuel, the present invention is not limited to these embodiments, but the present invention can be applied to an electric vehicle having one or more electrical motors as power sources, a hydrogen automobile having a power source of an engine using hydrogen as a fuel, and a hybrid vehicle using both an engine and an electric motor as power sources. In these cases, the power source to lower the torque is not limited to the engine 12, but the driving force of the electric motor may be lowered according to the present invention.

While the previously mentioned embodiments each including only one ECU have been explained, the invention is not limited to these embodiments, but the vehicle control apparatus may be constructed with a plurality of ECUs according to the present invention. For example, the ECU 100 forming part of each of the above described embodiments may be constructed by a plurality of ECUs such as an E-ECU that executes the combustion control of the engine 12, and a T-ECU that executes the transmission control of the automatic transmission 13 according to the present invention. In this case, each of the above ECUs may be operative to be held in communication with other ECUs for mutual input and output of necessary information.

As will be understood from the foregoing description, the vehicle control apparatus according to the present invention has such an advantageous effect that the vehicle control apparatus is operative to stop the reduction control of the driving force and can prevent a reduction of an engine output contrary to the intention of the driver to improve the operability of the vehicle in the case that an impact to the vehicle is small even if the accelerator pedal and the brake pedal are both depressed by the driver, thereby making it possible to prevent the drivability from being deteriorated. The vehicle control apparatus according to the present invention is therefore useful as a vehicle control apparatus that performs the suppression control of the output of a power source.

### REFERENCE SIGNS LIST

10: vehicle
12: engine (power source)
13: automatic transmission
14: front differential mechanism
15: rear differential mechanism
16: transfer
17L, 17R: front wheel
18L, 18R: rear wheel
21: propeller shaft
22L, 22R: front drive shaft
23L, 23R: rear drive shaft
41: differential gear case
53: transfer clutch
100: ECU (output control unit)
110: hydraulic pressure control device
120: operation panel
131: crank sensor
142: accelerator sensor (drive state detection unit, accelerator detection unit)
143: FB sensor (drive state detection unit, brake detection unit)
145: throttle sensor
160: vehicle speed sensor (drive state detection unit, vehicle speed detection unit)
163: transfer input rotation speed sensor
164: transfer output rotation speed sensor
165: distribution SW sensor
212: accelerator pedal
213: foot brake pedal
215: power changing switch

1. A vehicle control apparatus for a vehicle provided with a power source, an accelerator pedal, and a brake pedal, the vehicle control apparatus comprising:
a travel state detection unit that detects a travel state of the vehicle including a required amount of a driving force to be outputted by the power source,
an acceleration detection unit that detects an acceleration of the vehicle, and
an output control unit that executes a reduction control to reduce the driving force to be outputted by the power source in response to the required amount of the driving force,
the travel state detection unit being constituted by an accelerator detection unit that detects a depression of the accelerator pedal, and a brake detection unit that detects a depression of the brake pedal,
the output control unit being configured to execute the reduction control in the case that a variation occurred by a travel state of the vehicle detected by the travel state detection unit is estimated to be out of a preset protection range of the vehicle and the acceleration detected by the acceleration detection unit is smaller than or equal to a predetermined deceleration threshold value, under the condition that a prerequisite for establishing a control permission condition permitting the execution of the reduction control is satisfied, the prerequisite being that the depression of the accelerator pedal is detected by the accelerator detection unit and the depression of the brake pedal is detected by the brake detection unit, on the other hand, the output control unit being configured not to execute the reduction control in the case that the variation occurred by the travel state of the vehicle detected by the travel state detection unit is estimated to be within the preset protection range of the vehicle even if the prerequisite is satisfied,
the travel state detection unit including a vehicle speed detection unit that detects a vehicle speed,
the accelerator detection unit detecting the depression amount of the accelerator pedal, and
the deceleration threshold value is set on the basis of the vehicle speed detected by the vehicle speed detection unit and the depression amount of the accelerator pedal detected by the accelerator detection unit.

2. The vehicle control apparatus as set forth in claim 1, in which the output control unit is configured to estimate that the variation occurred by the travel state of the vehicle is within the protection range in the case that the depression amount of the accelerator pedal detected by the accelerator detection unit is less than or equal to a predetermined value.

3. The vehicle control apparatus as set forth in claim 1, in which the output control unit is configured to estimate that the variation occurred by the travel state of the vehicle is within the protection range in the case that the vehicle speed detected by the vehicle speed detection unit is smaller than or equal to a predetermined value.

4. The vehicle control apparatus as set forth in claim 1, in which the output control unit is configured to estimate that the variation occurred by the travel state of the vehicle is within the protection range in the case that the depression amount of the accelerator pedal detected by the accelerator detection unit is less than or equal to a predetermined value and the vehicle speed detected by the vehicle speed detection unit is smaller than or equal to a predetermined value.

5. The vehicle control apparatus as set forth in claim 1, in which the output control unit is configured not to execute the reduction control in the case that the acceleration detected by the acceleration detection unit is larger than a predetermined deceleration threshold value even if the prerequisite is satisfied.

6. The vehicle control apparatus as set forth in claim 2, in which the output control unit is configured to estimate that the variation occurred by the travel state of the vehicle is within the protection range in the case that the vehicle speed detected by the vehicle speed detection unit is smaller than or equal to a predetermined value.

7. The vehicle control apparatus as set forth in claim 2, in which the output control unit is configured not to execute the reduction control in the case that the acceleration detected by the acceleration detection unit is larger than a predetermined deceleration threshold value even if the prerequisite is satisfied.

8. The vehicle control apparatus as set forth in claim 3, in which the output control unit is configured not to execute the reduction control in the case that the acceleration detected by the acceleration detection unit is larger than a predetermined deceleration threshold value even if the prerequisite is satisfied.

9. The vehicle control apparatus as set forth in claim 4, in which the output control unit is configured not to execute the reduction control in the case that the acceleration detected by the acceleration detection unit is larger than a predetermined deceleration threshold value even if the prerequisite is satisfied.
